(19) United States
(12) Patent Application Publication
(10) Pub. No.: US 2009/0248656 A1
(43) Pub. Date: Oct. 1, 2009

(54) Search Engine Relevance Tuning Based on Instant Messaging (Influence Search Results Using IMS)

(76) Inventor: TOMI BLINNIKKA, San Pable, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/055,968

(22) Filed: Mar. 26, 2008

(51) Int. Cl. G06F 7/06

(52) U.S. Cl. 707/5; 707/E17.108

(57) ABSTRACT

To provide up-to-date search results containing Internet addresses that have become extremely popular very recently, search engines fine-tune search result rankings using communications sent by users of real-time messaging systems to each other. Instant messaging systems are one type of real-time messaging systems. Search engines use a URL found in instant messages to promote the ranking of Internet addresses and to refresh abstracts and caches. Similar demographics between the search engine user and senders of instant messages might be a requisite for promotion. The number of hops taken by a URL among instant messaging users might determine the extent of the promotion. To prevent unfair manipulation of search results, a URL should hop a threshold number of times. Call centers also promote the rankings of knowledge articles presented to call center operators based on how often keywords related to each knowledge article are detected in a conversation with a caller.

### FIELD OF THE INVENTION

The present invention relates to search technologies in general. More specifically, the invention relates to ranking search results by monitoring real-time communications.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Search engines are well known tools for searching on the Internet. Search results provided by search engines in response to search queries usually list a series of Internet addresses. The Internet addresses in the series are usually included in the search result because such Internet addresses have been sufficiently popular that a large number of other web sites have added hyperlinks to the Internet addresses. However, such search results do not reflect suddenly “hot” Internet addresses or topics that may be more relevant to the search engine user. Suddenly hot Internet addresses or topics become extremely popular in real-time and spread virally. For example, a news item may suddenly attract a spiked interest, and the interest in the news item suddenly spreads like a virus. The interest in the news item may just as quickly vanish. However, search engines often do not reflect in real-time what becomes hot within a time frame of a few hours. A search engine must wait for a web crawler to crawl through different portions of the web before Internet addresses from those portions may appear in search results. A search engine ought to be able to fine-tune search result rankings to reflect what is currently a hot topic or a hot Internet address without having to wait for a web crawler.

Customer service operators in a call center often must research information in some company intranet, the Internet, or a database. The customer service operators want the most relevant knowledge articles to solve their customer's problems. Because the ranking of knowledge articles are usually based on historical data, the customer service operators often must decide on their own which knowledge articles are of relevance to the immediate situation.

### Search Engines, URLs and Hyperlinks

When a user wants to search for information, typically, the user enters a search query at a webpage of a search engine, such as the search engine that is available at www.yahoo.com. The search engine would return a search result that is a series of “hyperlinks” (also called “hypertext links”) to Internet addresses which are most relevant to the search query. A hyperlink is some text or graphic that a user can select, the selection of which causes a web browser (or some other software or hardware) to retrieve or receive data found at an Internet address associated with the hyperlink. A user may select the text or graphic by any input method that can select such text or graphic, such as, but not limited to, a mouse, keyboard, speech recognition, touch, motion detection, mind reading, etc. The data received or retrieved may be any type of data, such as, but not limited to, text, images, video, audio, or data stored according to some proprietary format, such as Portable Document Format (“PDF”) from Adobe Acrobat. The data may be downloaded and stored at a user's location or streamed to the user's location.

An Uniform Resource Locator (URL) is a string of alphanumeric characters that references an Internet address. Different URLs may reference the same Internet address. For example, the URL may be “http://87.248.113.14”, or “http://www.yahoo.com”, which both reference the same Internet address. Some Web services allow for creating any arbitrary URL to reference an Internet address. For example, www.tinyurl.com allows creating a short URL to reference an Internet address that would otherwise be referenced by a long, convoluted URL. Typically, an URL is composed of an access protocol, a domain name, and perhaps the path to the file. For example, if the URL is “http://www.yahoo.com/sports”, then the access protocol is “http://”, the domain name is “www.yahoo.com”, and the path is “/sports”. An URL may be composed of other access protocols with other domain names or paths.

The Internet addresses listed in the search result likely provide the information the user is searching for. Typically, the Internet addresses listed are shown in order of likelihood of relevance, or a “ranking”, with the Internet address nearest to the top of the displayed search result being the most relevant with a highest ranking, and reducing in relevancy as each Internet address is listed on downwards on the webpage. The search results typically include at least an abstract of each Internet address, a hyperlink to the Internet address, and a hyperlink to a cached copy of the data found at the Internet address.

### Instant Messaging

A popular communication medium on the Internet is instant messaging, which is one type of real-time messaging in which users of instant messaging services communicate in real-time. Instant messaging refers to real-time electronic text or graphical communications between two or more users who are logged into an instant messaging system with an open channel of communication used for immediate correspondence. The channel of communication is open for at least the duration of the communication. A user usually may see whether other users are online, and open a channel of communication to another user by sending an initial instant message. The users are usually present at each end of the communication channel, exchanging text or graphics while the channel of communication is open. Users usually have the option of storing or not storing the contents of their communications. Stored communications are usually grouped under a user-id of the person with whom the communication was established. Examples of instant messaging services are the Yahoo messenger service, the MSN messenger service, ICQ, and AOL's Aim service. Traditionally, instant messaging services are sent and received between users on the Internet or some other TCP/IP network.

“Text messages” are sent to and from cellular phones on a Short Message Service (SMS) network. SMS is a protocol for sending and receiving text messaging over digital cellular networks. Real-time messaging may also take on a hybrid form when such messages are sent to and from a machine on a TCP/IP network and a cellular phone using a SMS service.

### Related Techniques

Recent techniques to keep track of what Internet addresses are popular include counting the number of hyperlinks to an Internet address from other web sites and by examining bookmarks. Counting the number of hyperlinks to the Internet address, however, reveals relatively static information. Except for Internet addresses that contain webpages with breaking news, hyperlinks generally are relatively static in that hyperlinks are not usually updated to point to an Internet address that has become hot within the last few hours. Bookmarking sites such as del.icio.us can analyze what users are bookmarking to figure out what is popular, but such systems also don't take into account the real-time aspect. Bookmarks generally are somewhat static and do not reflect what may have become popular within a short timeframe of a few hours. Some online e-mail systems examine the contents of e-mail to give relevant advertising to the e-mail user, but this does not affect rankings of query results. Search engines also know what topics are hot in real-time by keeping track of popular keywords in search queries. However, this does not give any information that can promote the rankings of specific Internet addresses.

In view of the above, it is desirable to provide criteria for fine-tuning ranking of Internet addresses to reflect what is hot in real-time.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an embodiment of the invention for a peer-to-peer instant messaging system.

FIG. 2 is a block diagram illustrating an embodiment of the invention for a server-based instant messaging system.

FIG. 3 is a block diagram illustrating an embodiment of the invention for fine-tuning knowledge article rankings in a call center environment.

FIG. 4 is a flow diagram illustrating a technique for detecting URLs in instant messages with client-server instant messaging, according to an embodiment of the invention.

FIG. 5 is a flow diagram illustrating a technique for detecting keywords in phone calls to call centers, according to an embodiment of the invention.

FIG. 6 is a flow diagram illustrating a technique for promoting Internet address rankings in search results, according to an embodiment of the invention.

FIG. 7 is a flow diagram illustrating a technique for promoting knowledge article rankings in search results, according to an embodiment of the invention.

FIG. 8 is a flow diagram illustrating another technique for promoting Internet address rankings in search results, according to an embodiment of the invention.

FIG. 9 is a flow diagram illustrating another technique for promoting knowledge article rankings in search results, according to an embodiment of the invention.

FIG. 10 is a flow diagram illustrating a technique for detecting URLs in instant messages with peer-to-peer instant messaging, according to an embodiment of the invention.

FIG. 11 is a block diagram illustrating a computer system that may be used in implementing an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### Overview

To overcome the shortcomings of existing Internet address ranking techniques, an improved mechanism is provided for ranking Internet addresses. Users of instant messaging services often send to receiving users URLs that reflect Internet addresses of interest. An Internet address is “hot” if the popularity of the Internet address for a given short time frame has increased passed a certain threshold. A useful measure of the popularity of an Internet address within that short timeframe is the number of URLs to that Internet address passed from a sending user to a receiving user via instant messaging. Search engines can use the detected communication of URLs to fine-tune search result rankings to reflect sudden increases in popularity of Internet addresses referenced by the URLs. Such fine-tuning is effected by a search engine promoting the ranks of Internet addresses referenced by the URLs.

In an embodiment, search engines refine the rankings of Internet addresses in search results by monitoring real-time communications. In an embodiment, a search engine uses URLs detected from instant messages sent over a TCP/IP network to determine what is popular at any moment in time. The search engine then uses such real-time information for ranking Internet addresses in search results.

In another embodiment, such real-time communications are SMS messages sent or received by cell phones. In yet another embodiment, such real-time communications are a hybrid of TCP/IP instant messages and SMS messages. In an embodiment, instead of URLs, search engines detect a set of keywords for promoting Internet addresses associated with the set of keywords. Although specific network communication protocols such as TCP/IP and SMS are disclosed herein as illustration, embodiments of the invention are not limited to the disclosed network communication protocols. Although a search engine is recited herein as performing method steps, in other embodiments an agent or mechanism acting on behalf of the search engine may perform the method steps. While specific embodiments of the invention are described in which a search engine or a call center support application (“CCSA”) uses the disclosed techniques described herein, the techniques described herein are not limited to the disclosed embodiments of the invention and the techniques described herein may be applicable to other embodiments.

### Promotion and URL Detection

In an embodiment, a search engine detects within instant messages a URL that references an Internet address. In an embodiment, a search engine uses pattern matching to detect alphanumeric strings that resemble a URL. For example, any of “http://” or “www” are clues that users are communicating a URL. Once the URL is detected, the search engine might use the URL to promote the rankings of Internet addresses associated with the URL. In an embodiment, a search engine promotes the ranking of the Internet address matching exactly the detected URL. In an embodiment, the search engine might also promote related Internet addresses with similar URLs, i.e. from the same website but located in other subdirectories. For example, the search engine might also promote “http://www.yahoo.com/sports/highlights” for a URL composed of “http://www.yahoo.com/sports/dailyscores”. In an embodiment, the search engine might also promote the top-level domain of the URL. For example, the search engine might also promote “www.yahoo.com” for a URL composed of “http://www.yahoo.com/sports”. In an embodiment, a definable parameter allows a search engine user to specify the degree to which a search engine promotes Internet addresses not exactly referenced by the detected URL but are nonetheless related to the Internet address referenced exactly by the detected URL. In an embodiment, a definable parameter allows a search engine provider to specify the degree to which the search engine promotes Internet addresses not exactly referenced by the detected URL but are nonetheless related to the Internet address referenced exactly by the detected URL.

### Peer-to-Peer Instant Messaging

In some instant messaging software, clients send instant messages directly to other instant messaging clients in a peer-to-peer fashion. In an embodiment, an instant messaging system uses client-side software to scan each outgoing instant message for URLs. The client-side software sends the URLs plus information about the identity of the sending user to a search engine. The search engine uses the information received from instant messaging clients to determine whether search result rankings should be affected. In an embodiment, a tracking service, as part of a search engine or in communication with a search engine, processes the URLs and any identity information received from instant messaging clients. The tracking service may monitor and count the number of times that a URL is communicated in a sequence across at least a threshold number of different nodes of a network.

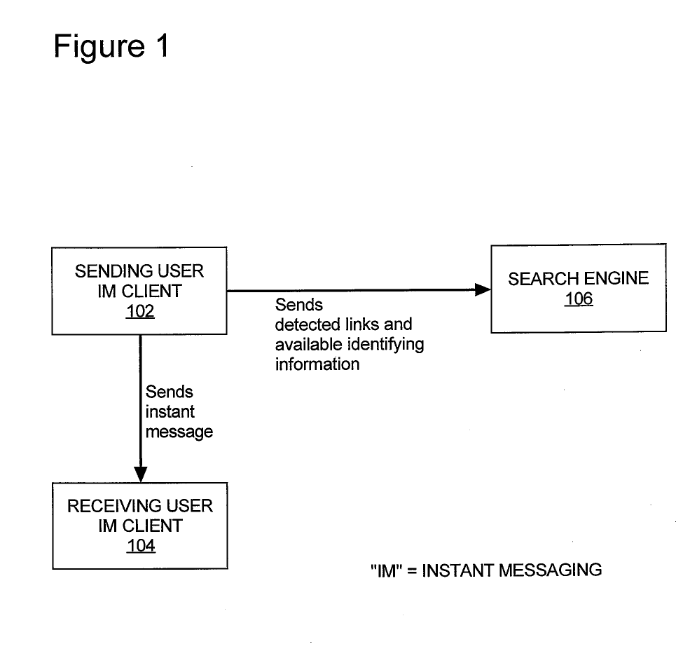

FIG. 1 illustrates an embodiment of the invention for a peer-to-peer instant messaging system. In FIG. 1, a user of an instant messaging system uses SENDING USER IM CLIENT 102 to send instant messages to RECEIVING USER IM CLIENT 104. SENDING USER IM CLIENT 102 extracts detected URLs and available identifying information from instant messages sent and the sending user's profile. SENDING USER IM CLIENT 102 sends the detected URLs and any available identifying information to SEARCH ENGINE 106. SENDING USER IM CLIENT 102 sends instant messages directly to RECEIVING USER IM CLIENT 104.

### Client-Server Instant Messaging

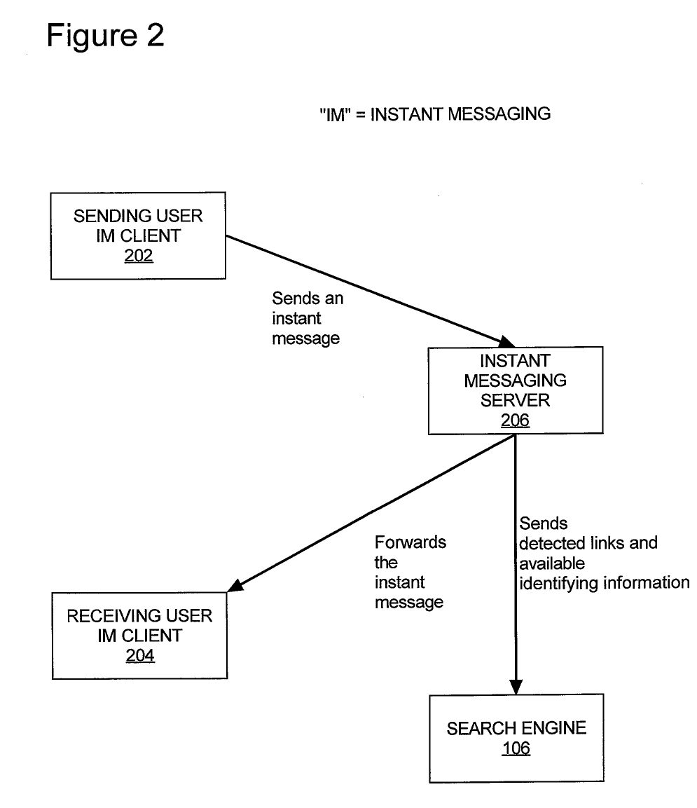

In an embodiment, server-side software in an instant messaging system scans each communicated instant message for URLs, if all instant messages are delivered via centralized servers and do not use peer-to-peer delivery of instant messages. In an embodiment, the server-side software monitors and counts the number of times that a URL is communicated in a sequence across at least a threshold number of different nodes of a network. FIG. 2 illustrates an embodiment of the invention for a server-based instant messaging system. In FIG. 2, a user of an instant messaging system uses SENDING USER IM CLIENT 202 to send instant messages to RECEIVING USER IM CLIENT 204. The client-server instant messaging system as depicted in FIG. 2 routes instant messages through an INSTANT MESSAGING SERVER 206. INSTANT MESSAGING SERVER 206 extracts the detected URLs and any available identifying information, and sends the detected URLs and any extracted identifying information to SEARCH ENGINE 106. INSTANT MESSAGING SERVER 206 also forwards the instant messages to RECEIVING USER IM CLIENT 204.

### Preventing Manipulation of Ranking Promotion

In an embodiment, a search engine detects that an URL is communicated through a threshold number of nodes of a network in a sequence before the search engine will use the URL to fine-tune rankings of Internet addresses. That is, unless the URL “hops” across at least the threshold number of different network nodes, the search engine will not use the URL. For example, user A communicates the URL to user B, who communicates the URL to user C. This series of two hops may be represented by “A→B→C”. If the threshold number of hops required is 3 hops, then the two hops made by the URL in this example is insufficient for the URL to be considered when ranking search results. If there are three hops, for example, “A→B→C→D”, then the search engine might use the URL in fine-tuning rankings. The prerequisite of a threshold number of hops helps to prevent manipulation of search result rankings. In an embodiment, the number of hops made by a URL determines the extent of the promotion given to the ranking of an Internet address that the URL references. In an embodiment, if no identifying information is available for the users who communicate the URL, the search engine raises the threshold number of hops required before the URL will be used to fine-tune rankings.

As time passes, Internet addresses that were once hot are no longer as popular. Sometimes, interest in Internet addresses vanish quite quickly. In an embodiment, a search engine reduces a promotion given to the rank of an Internet address over some time interval. In an embodiment, a search engine reduces promoted rankings by a standard quantity of ranking measure per day. In an embodiment, a search engine promotes rankings that have their promotion previously reduced upon detecting a threshold number of new hops made by an URL similar to the earlier URL that originally caused the promotion. In an embodiment, the detection of keywords associated with Internet addresses may also promote the ranks of the Internet addresses.

### Promoting Ranks—Peer-to-Peer Instant Messaging

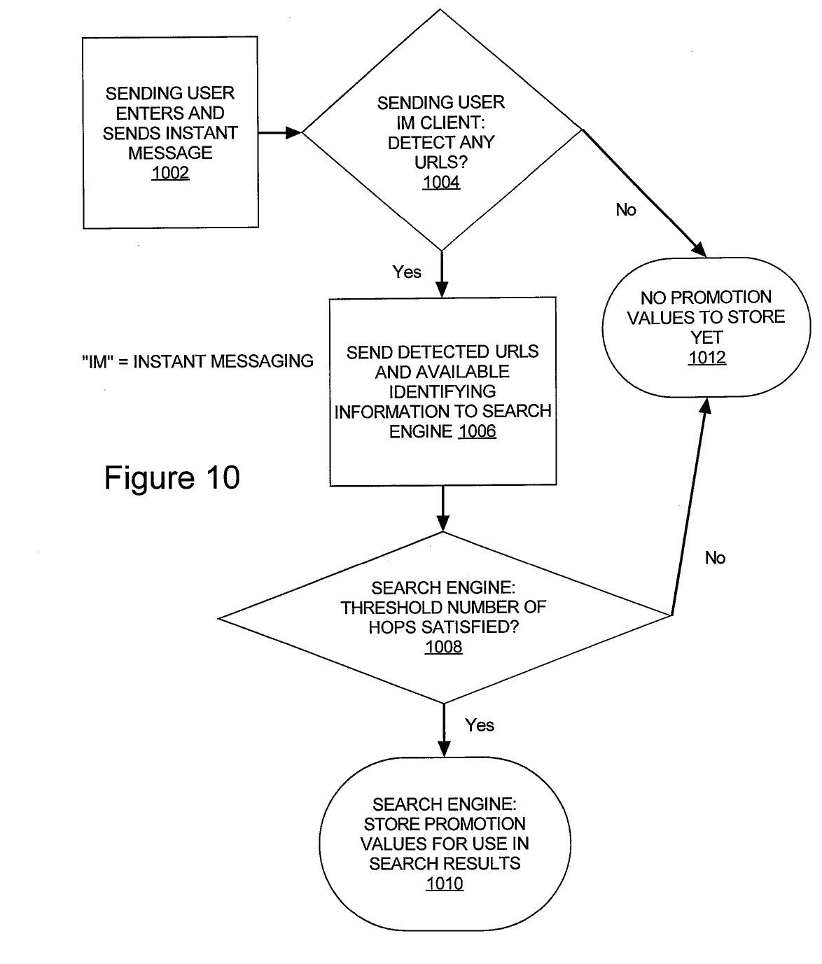

FIG. 10 is a flow diagram illustrating a technique for detecting URLs in instant messages with peer-to-peer instant messaging, according to an embodiment of the invention. In step 1002, a sending user enters and sends an instant message at SENDING USER IM CLIENT 202. In step 1004, SENDING USER IM CLIENT 202 checks the instant message for URLs. In step 1006, if there are any URLs in the message, SENDING USER IM CLIENT 202 sends the URLs and any extracted identification information to SEARCH ENGINE 106. In step 1008, SEARCH ENGINE 106 determines if there have been a threshold number of hops made by the URLs detected. If yes, in step 1010, SEARCH ENGINE 106 stores promotion values for use in search results, for the URLs that have satisfied the threshold number of hops. Otherwise, if no URLs have a sufficient number of hops, SEARCH ENGINE 106 does not store any promotion values at this time, in step 1012.

### Promoting Ranks—Client/Server Instant Messaging

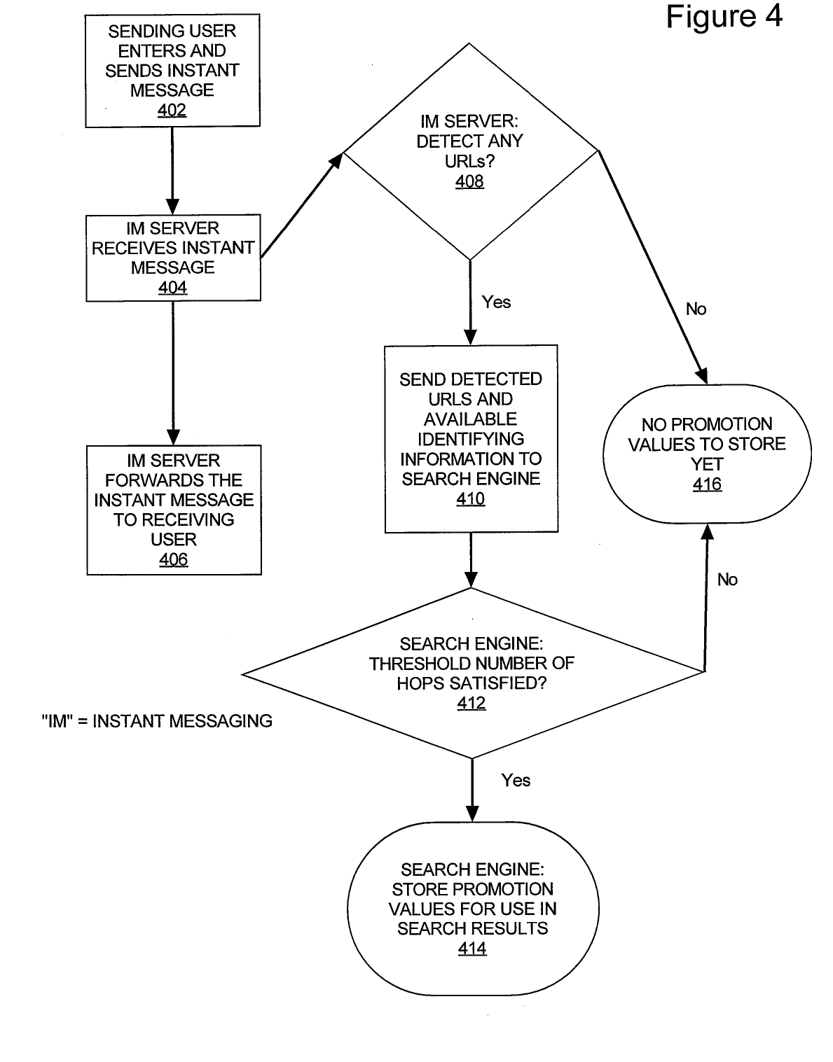

FIG. 4 is a flow diagram illustrating a technique for detecting URLs in instant messages with client-server instant messaging, according to an embodiment of the invention. In FIG. 4, a sending user who wants to send an instant message to a receiving user in a client-server instant messaging system enters and sends an instant message at SENDING USER IM CLIENT 202 in step 402. INSTANT MESSAGING SERVER 206 receives the instant message from SENDING USER IM CLIENT 202 in step 404. INSTANT MESSAGING SERVER 206 forwards the instant message to RECEIVING USER IM CLIENT 204 in step 406. INSTANT MESSAGING SERVER 206 also inspects the instant message to detect URLs in step 408. If any URLs are detected, INSTANT MESSAGING SERVER 206 sends the detected URLs and available identifying information that can be extracted to SEARCH ENGINE 106 in step 410. In an embodiment, SEARCH ENGINE 106 decides whether there has been the threshold number of hops made by the URLs, in step 412. If the URLs have made the threshold number of hops, SEARCH ENGINE 106 stores a promotion value for each of the Internet addresses referenced by the URLs, for use in fine-tuning search result rankings in step 414. Otherwise, in step 416, the URLs have not yet made the threshold number of hops required, and there are no promotion values to store.

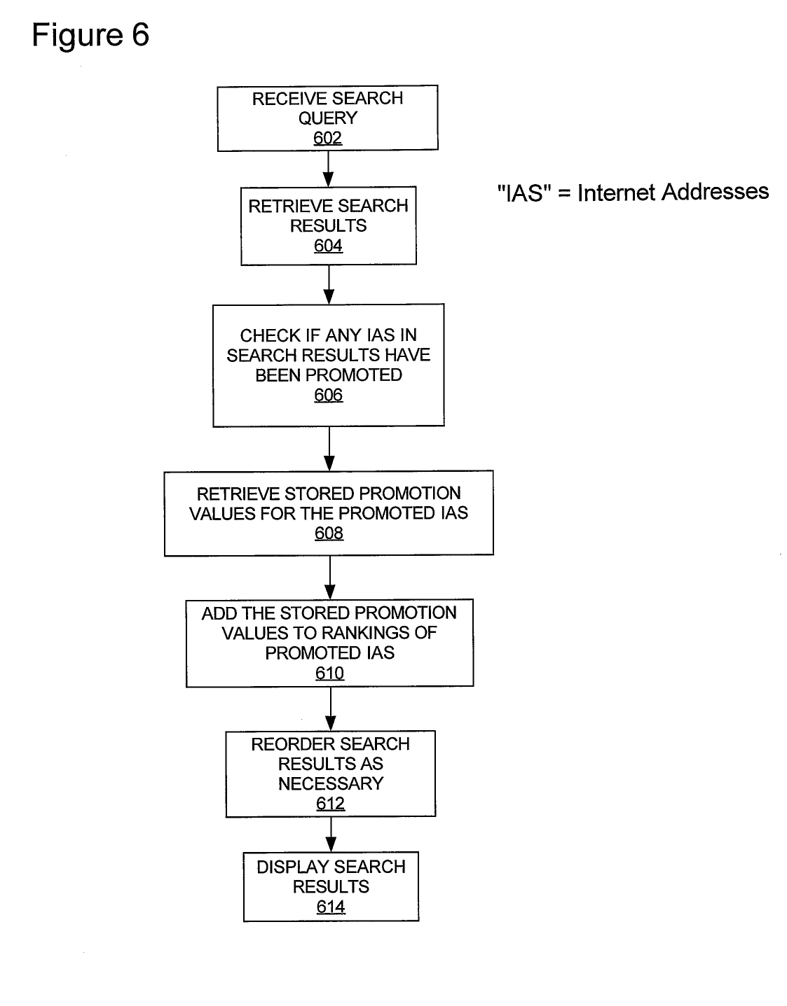

FIG. 6 is a flow diagram illustrating a technique for promoting Internet address rankings in search results, according to an embodiment of the invention. In one embodiment, when a search engine user enters a search query, SEARCH ENGINE 106 performs the steps of FIG. 6 to fine-tune the rankings of Internet addresses in a search result. Although FIG. 6 illustrates one technique as performed in one embodiment of the invention disclosed herein, in other embodiments of the invention SEARCH ENGINE 106 might perform the steps in a different order or using similar techniques. In FIG. 6, SEARCH ENGINE 106 receives a search query in step 602 and retrieves search results in step 604. Some of the Internet addresses in the search results may have had their ranking temporarily promoted, and so SEARCH ENGINE 106 checks for promoted rankings in step 606. SEARCH ENGINE 106 retrieves stored promotion values indicating how much to promote the ranking of the Internet addresses in step 608. For example, a stored promotion value might indicate to move the promoted Internet address up three rank listings. Or, a stored promotion value might indicate to move the promoted Internet address to the very top of the search result rank listings. SEARCH ENGINE 106 adds the stored promotion values to the rankings of the promoted Internet addresses in step 610. SEARCH ENGINE 106 reorders the search results with the new promoted rankings in step 612. SEARCH ENGINE 106 displays the search results in step 614.

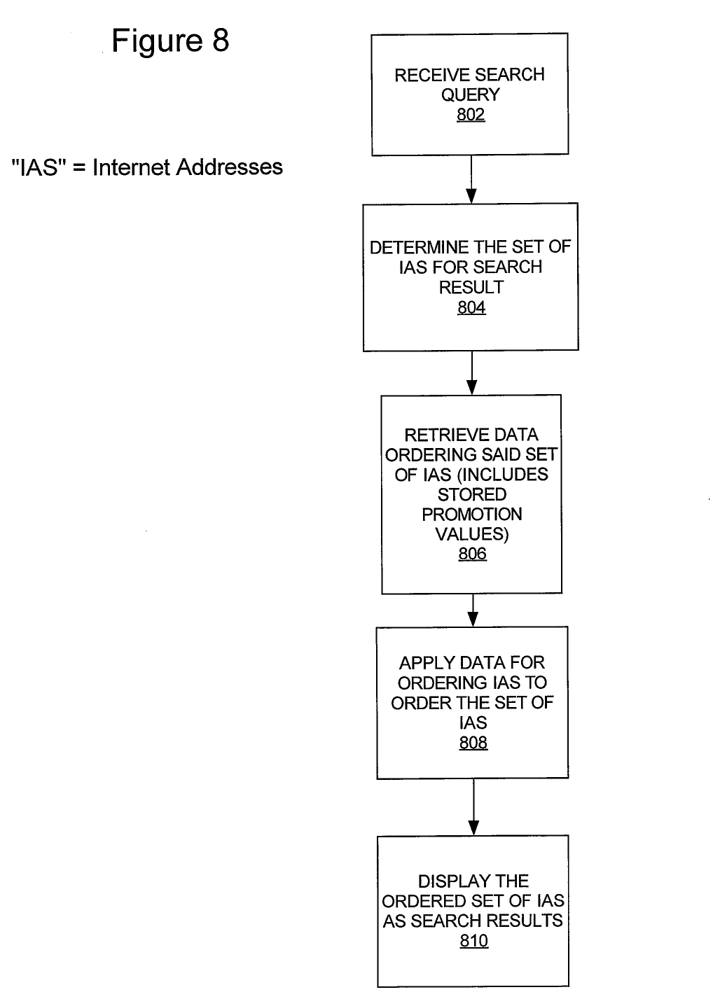

FIG. 8 is a flow diagram illustrating another technique for promoting Internet address rankings in search results, according to an embodiment of the invention. In the embodiment illustrated in FIG. 8, when a search engine user enters a search query, a SEARCH ENGINE 106 performs the steps of FIG. 8 to rank Internet addresses. Although FIG. 8 illustrates a technique as performed in an embodiment of the invention, in yet other embodiments of the invention SEARCH ENGINE 106 might perform the steps in a different order or using similar techniques. In FIG. 8, SEARCH ENGINE 106 receives a search query in step 802. In step 804, SEARCH ENGINE 106 determines the set of Internet addresses that may be used as the search result. In step 806, SEARCH ENGINE 106 retrieves data that orders the set of Internet addresses. The data includes stored promotion values. In step 808, SEARCH ENGINE 106 applies the data to order the set of Internet addresses. In step 810, SEARCH ENGINE 106 displays, as search results, the set of Internet addresses that have been ordered.

### Promoting Rankings According to Demographics

In an embodiment, a search engine fine-tunes rankings for search results provided to a certain demographic group by considering what Internet addresses are hot for that particular demographic group. In an embodiment, a search engine makes use of user profiles stored at a client of an instant messaging system to determine relevant demographic information. In an embodiment, a search engine maintains an index of Internet addresses, a popularity weight for each Internet address, and a demographic group pertaining to that popularity weight. For example, an Internet address stored in the index may be for some Internet address with a news item webpage about Britney Spears. In an embodiment, the popularity weight for the Internet address of the Britney Spears news item webpage may equal 9 out of 10, with a maximum of 10 on the popularity scale. A sample demographic group pertaining to that popularity weight may be 18-25 year old college students. Thus, in this example, a search engine user that is an 18-25 year old college student who requests search results regarding Britney Spears will receive search results ranked with some fine-tuning that reflects the temporarily promoted popularity of the Internet address with the Britney Spears news item webpage.

In an embodiment, a search engine has demographic information when search engine users fill in their demographic information into user profiles and log into their accounts. Another method of getting search engine user demographic information is to profile the search engine user according to his or her activities. A search engine can use a cookie to keep track of web sites that the search engine user often visits. For example, if the search engine user often visits AARP web sites, then the search engine user is likely a senior citizen. This provides the necessary demographic information regarding the search engine user to rank search results using popularity weights.

### Automatic Refresh

In an embodiment, once an Internet address becomes hot because instant messaging users send and receive a sufficient number of real-time messages containing URLs to the Internet address, a web crawler for a search engine automatically refreshes at least the abstract and cache of data retrieved from Internet address for presentation in future search results. Unless the search engine refreshes at least the abstract and cache, when a receiving user in an instant messaging system uses the search engine, the receiving user will see non-updated abstracts and caches. Such non-updated abstracts and caches do not reflect what the sending user intended for the receiving user to see.

In other embodiments, a search engine might refresh other data regarding the Internet address. For example, a search engine might refresh a preview picture of a webpage at the Internet address. The search engine might also refresh metadata regarding the webpage. For example, the search engine might refresh a record of the date the data at the Internet address was most recently modified. Although search engines are disclosed herein as refreshing abstracts, caches, preview pictures, and modification dates for illustration purposes, in other embodiments search engines, or agents or mechanisms acting on behalf of search engines, might refresh still other data or metadata. Embodiments of the invention are not limited to refreshing abstracts, caches, preview pictures, and modification dates as disclosed herein. In an embodiment, a call center support application also refreshes data and metadata related to knowledge articles.

### Call Center Support Application Embodiment

Callers to a call center seek to resolve specific issues. Often, many different customers have similar problems that become hot topics in any given hour. For example, a caller might want to know how to fix a software application. A call center often receives many similar phone calls related to how to fix a software application when a new version is deployed. By monitoring the topics of discussion in the customer support telephone conversation, a CCSA can recognize and utilize hot topics that are relevant at the moment to fine-tune the ranking of knowledge articles presented to a call center operator. Such fine-tuning should reflect hot topics among many phone calls received at relevant call centers. In an embodiment, a CCSA decides that a topic is hot when a threshold number of unique callers mention a set of keywords.

In an embodiment, a CCSA monitors phone calls, in order to fine-tune the ranking of search results that best provide solutions to each caller's specific issues. In one embodiment, the search results are knowledge articles. In an embodiment, a CCSA may display ranked knowledge articles to a call center operator without requiring the call center operator to type in a search query. In an embodiment, an agent or mechanism acts on behalf of the CCSA to perform the method steps. In an embodiment, a CCSA ranks knowledge articles on an Internet address directly accessible to would-be callers. Would-be callers can then independently solve their problems without calling the call center.

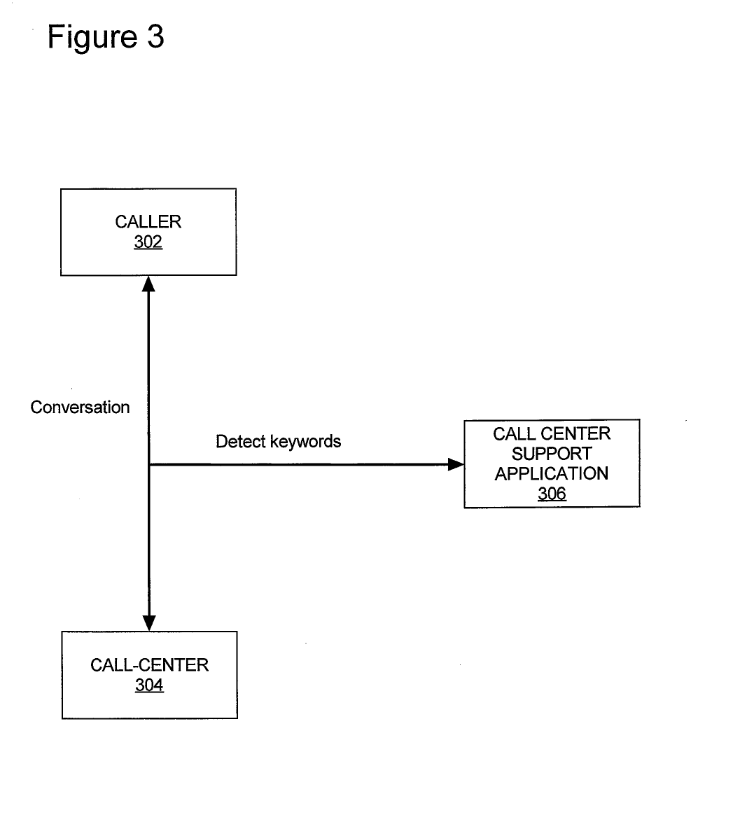

FIG. 3 is a block diagram illustrating an embodiment of the invention for fine-tuning knowledge article rankings in a call center environment. In FIG. 3, CALLER 302 in need of assistance calls CALL CENTER 304. While CALLER 302 and an operator at CALL CENTER 304 are conversing, CALL CENTER SUPPORT APPLICATION 306 monitors the conversation and detects keywords from the conversation to use in ranking knowledge articles.

### Detecting Keywords

In an embodiment, knowledge articles are associated with keywords. In one embodiment, a CCSA uses keywords detected in a conversation with a caller to improve rankings of potentially useful knowledge articles, in order to help determine which knowledge articles are relevant for resolving a customer call. In an embodiment, a CCSA monitors communications such as telephone conversations and other telephony communications between callers and call center operators. In an embodiment, a CCSA uses speech recognition software to detect keywords. In an embodiment, a database contains a list of relevant keywords for each knowledge article. In an embodiment, a CCSA examines the written record of each communication for keywords. For example, a CCSA examines a written call log of a caller's specific issues for keywords. The written record may be stored using any machine-readable storage medium. In an embodiment, the more often conversations mentions keywords associated with a knowledge article, the greater the promotion of the rank of the knowledge article.

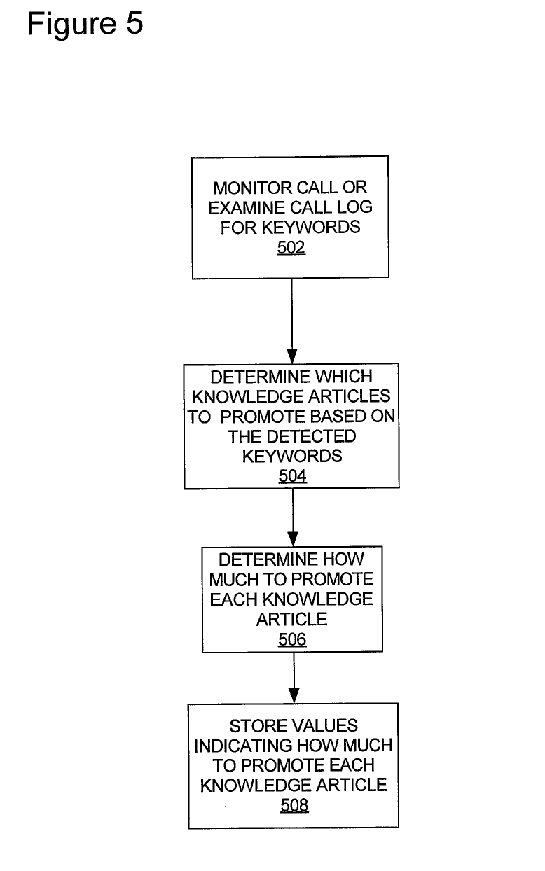

FIG. 5 is a flow diagram illustrating a technique for detecting keywords in phone calls made to call centers, according to an embodiment of the invention. In an embodiment, CCSA 306 performs the technique illustrated in FIG. 5. In FIG. 5, CCSA 306 monitors a call or examines a call log for keywords in step 502. CCSA 306 determines which knowledge articles to promote based on the detected keywords in step 504. CCSA 306 determines how much to promote the ranking of each knowledge article in step 506. CCSA 306 stores values indicating how much to promote each knowledge article in step 506.

### Promoting Knowledge Articles

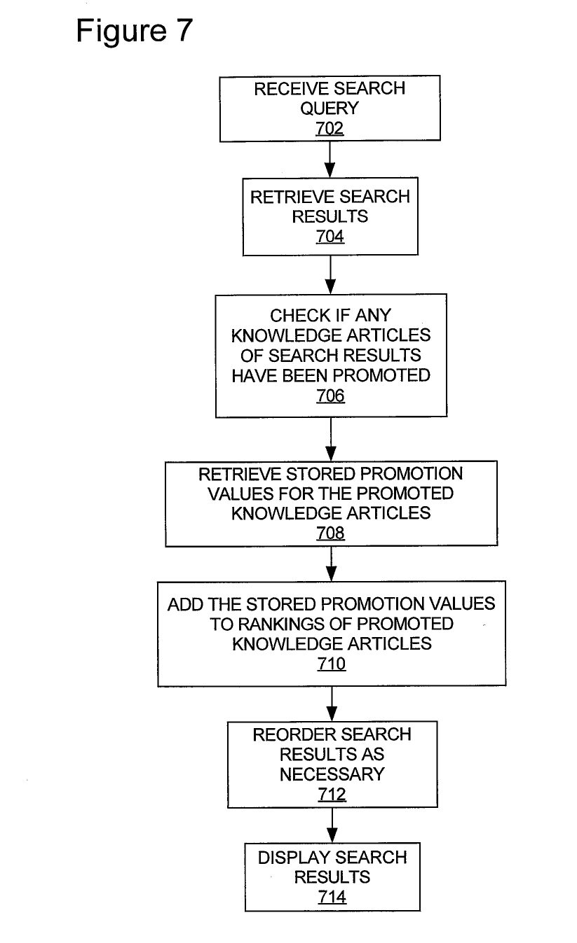

FIG. 7 is a flow diagram illustrating a technique for promoting knowledge article rankings in search results, according to an embodiment of the invention. In one embodiment, when a call center operator wishes to retrieve relevant knowledge articles to help resolve a call, CCSA 306 performs the steps of FIG. 7 to fine-tune the rankings of knowledge articles. Although FIG. 7 illustrates one technique as performed in one embodiment of the invention disclosed herein, in other embodiments of the invention CCSA 306 might perform the steps in a different order or using similar techniques. In FIG. 7, CCSA 306 receives a search query in step 702 and retrieves search results in step 704. Some of the knowledge articles in the search results may have had their ranking temporarily promoted, and so CCSA 306 checks for promoted rankings in step 706. CCSA 306 retrieves stored promotion values indicating how much to promote the ranking of the knowledge articles in step 708. For example, a stored promotion value might indicate to move a knowledge article up three rank listings. Or, a stored promotion value might indicate to move a knowledge article to the very top of the search result rank listings. CCSA 306 adds the stored promotion values to the rankings of the promoted knowledge articles in step 710. CCSA 306 reorders the search results with the new promoted rankings in step 712. CCSA 306 displays search results in step 714.

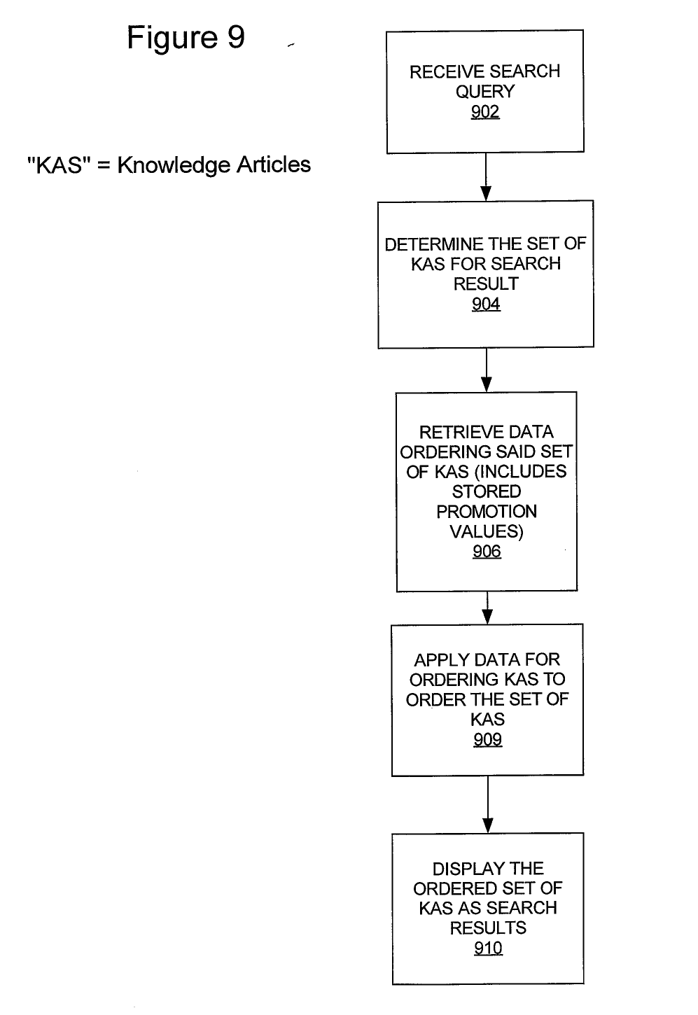

FIG. 9 is a flow diagram illustrating another technique for promoting knowledge article rankings in search results, according to an embodiment of the invention. In the embodiment illustrated in FIG. 9, when a call center operator wishes to retrieve relevant knowledge articles to help resolve a call, CCSA 306 performs the steps of FIG. 9 to rank knowledge articles. Although FIG. 9 illustrates a technique as performed in an embodiment of the invention, in yet other embodiments of the invention CCSA 306 might perform the steps in a different order or using similar techniques. In FIG. 9, CCSA 306 receives a search query in step 902. In step 904, CCSA 306 determines the set of knowledge articles that may be used as the search result. In step 906, CCSA 306 retrieves data that orders the set of knowledge articles. The data includes stored promotion values. In step 908, CCSA 306 applies the data to order the set of knowledge articles. In step 910, CCSA 306 displays, as search results, the set of knowledge articles that have been ordered.

### Hardware Overview

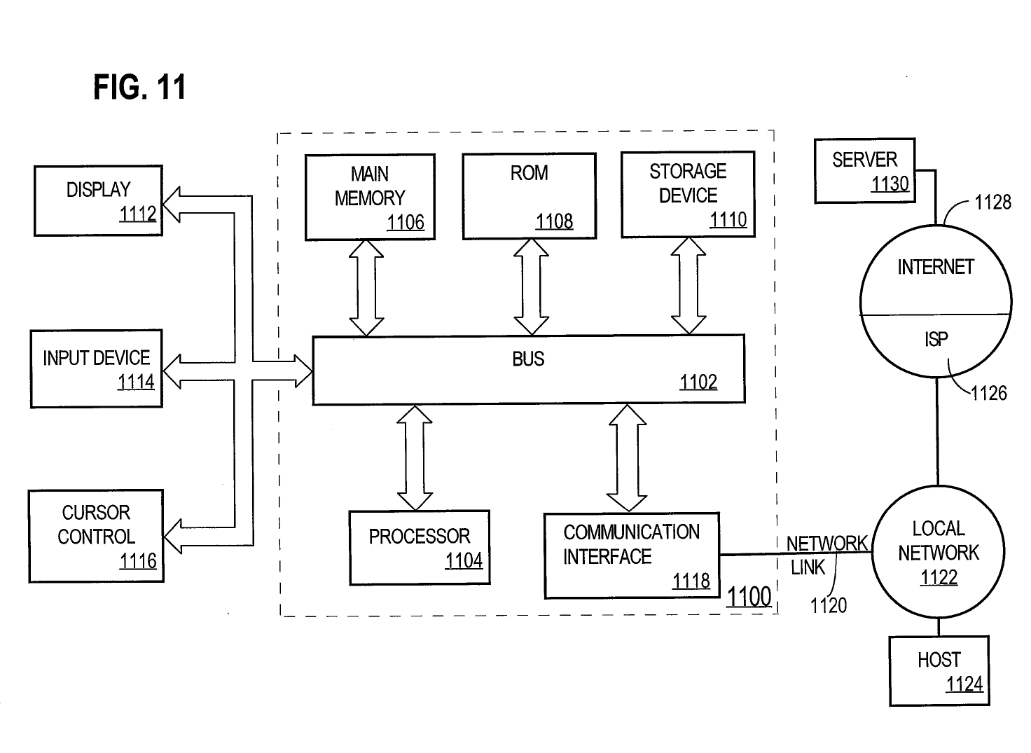

FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

The invention is related to the use of computer system 1100 for implementing the techniques described herein. According to one embodiment of the invention, those techniques are performed by computer system 1100 in response to processor 1104 executing one or more sequences of one or more instructions contained in main memory 1106. Such instructions may be read into main memory 1106 from another machine-readable medium, such as storage device 1110. Execution of the sequences of instructions contained in main memory 1106 causes processor 1104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1100, various machine-readable media are involved, for example, in providing instructions to processor 1104 for execution. Such a medium may take many forms, including but not limited to storage media and transmission media. Storage media includes both non-volatile media and volatile media. Non-volatile media includes, for example, optical or magnetic disks, such as storage device 1110. Volatile media includes dynamic memory, such as main memory 1106. Transmission media includes coaxial cables, copper wire and fiber optics, including the wires that comprise bus 1102. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method to fine-tune a ranking of an Internet address in a search result, comprising computer-executed steps of:
detecting a reference that identifies said Internet address in a real-time electronic communication;
sending said reference to a service receiving said reference; and
wherein said reference is used to change said ranking of said Internet address in said search result.

2. The method of claim 1, further comprising:
wherein said real-time electronic communication is an instant message.

3. The method of claim 1, further comprising:
determining one or more data identifying a user, wherein said user created said real-time electronic communication;
wherein sending further comprises sending said one or more data; and
wherein said one or more data is also used to change said ranking of said Internet address in said search result.

4. The method of claim 1, further comprising:
wherein said reference is used to change a different ranking of a different Internet address in said search result.

5. A method to fine-tune rankings in a search result, comprising computer-executed steps of:
receiving a reference that identifies an Internet address;
determining that said reference satisfies a criteria comprising: that said reference has been mentioned in at least a first threshold number of real-time electronic communications; and
changing rankings of said search result based, at least partially, upon said criteria being satisfied.

6. The method of claim 5, further comprising:
wherein a search engine performs changing rankings of said search result.

7. The method of claim 5, further comprising:
receiving data identifying a user, wherein said user created an electronic communication counted as part of said first threshold number of real-time electronic communications.

8. The method of claim 5, further comprising:
said criteria further comprising: determining that there are at least a second threshold number of unique creators of a plurality of real-time electronic communications mentioning said reference.

9. The method of claim 5, further comprising:
said criteria further comprising: deciding that a user who requested said search result is in a same demographic group as a set of unique creators of a plurality of real-time electronic communications containing said reference.

10. The method of claim 5, further comprising:
reducing a rank of said Internet address after a promotion of said rank of said Internet address.

11. The method of claim 5, further comprising:
wherein changing rankings is performed by promoting a rank of said Internet address.

12. The method of claim 5, further comprising:
wherein said first threshold number is increased in response to not receiving any identifying information for any senders of said real-time electronic communications.

13. The method of claim 5, further comprising:
automatically updating cached data associated with said Internet address in response to determining that said criteria has been satisfied.

14. A method to fine-tune a ranking of a plurality of documents, comprising computer-executed steps of:
examining a conversation between at least two parties;
detecting that a keyword has been mentioned in said conversation at least a threshold number of times; and
changing said ranking of said plurality of documents based, at least partially, upon detecting that said keyword has been mentioned in said conversation at least said threshold number of times.

15. The method of claim 14, further comprising:
wherein said conversation is a written record comprising of at least a partial summary to of an oral conversation.

16. The method of claim 14, further comprising:
wherein changing said ranking is performed after determining that a threshold number of conversations has mentioned said keyword.

17. The method of claim 14, further comprising:
wherein a webpage displaying said ranking of said plurality of documents is shown to a user who was not one of said at least two parties to said conversation.

18. The method of claim 14, further comprising:
wherein a software application used in a call center performs changing said ranking of said plurality of documents.

19. A computer-readable medium carrying one or more sequences of instructions which, when executed by one or more processors, causes the one or more processors to perform the method recited in claim 1.

20. A computer-readable medium carrying one or more sequences of instructions which, when executed by one or more processors, causes the one or more processors to perform the method recited in claim 2.

21. A computer-readable medium carrying one or more sequences of instructions which, when executed by one or more processors, causes the one or more processors to perform the method recited in claim 3.

22. A computer-readable medium carrying one or more sequences of instructions which, when executed by one or more processors, causes the one or more processors to perform the method recited in claim 4.

23. A computer-readable medium carrying one or more sequences of instructions which, when executed by one or more processors, causes the one or more processors to perform the method recited in claim 5.

24. A computer-readable medium carrying one or more sequences of instructions which, when executed by one or more processors, causes the one or more processors to perform the method recited in claim 6.

25. A computer-readable medium carrying one or more sequences of instructions which, when executed by one or more processors, causes the one or more processors to perform the method recited in claim 7.

26. A computer-readable medium carrying one or more sequences of instructions which, when executed by one or more processors, causes the one or more processors to perform the method recited in claim 8.

27. A computer-readable medium carrying one or more sequences of instructions which, when executed by one or more processors, causes the one or more processors to perform the method recited in claim 9.

28. A computer-readable medium carrying one or more sequences of instructions which, when executed by one or more processors, causes the one or more processors to perform the method recited in claim 10.

29. A computer-readable medium carrying one or more sequences of instructions which, when executed by one or more processors, causes the one or more processors to perform the method recited in claim 11.

30. A computer-readable medium carrying one or more sequences of instructions which, when executed by one or more processors, causes the one or more processors to perform the method recited in claim 12.

31. A computer-readable medium carrying one or more sequences of instructions which, when executed by one or more processors, causes the one or more processors to perform the method recited in claim 13.

32. A computer-readable medium carrying one or more sequences of instructions which, when executed by one or more processors, causes the one or more processors to perform the method recited in claim 14.

33. A computer-readable medium carrying one or more sequences of instructions which, when executed by one or more processors, causes the one or more processors to perform the method recited in claim 15.

34. A computer-readable medium carrying one or more sequences of instructions which, when executed by one or more processors, causes the one or more processors to perform the method recited in claim 16.

35. A computer-readable medium carrying one or more sequences of instructions which, when executed by one or more processors, causes the one or more processors to perform the method recited in claim 17.

36. A computer-readable medium carrying one or more sequences of instructions which, when executed by one or more processors, causes the one or more processors to perform the method recited in claim 18.
